(19) United States
(12) Patent Application Publication
(10) Pub. No.: US 2023/0250846 A1
(43) Pub. Date: Aug. 10, 2023

(54) THIN HINGE

(71) Applicant: Sinher Technology Inc., New Taipei (TW)

(72) Inventors: Chih-Huang PENG, New Taipei (TW); Chun-Fu LIN, New Taipei (TW)

(21) Appl. No.: 18/100,719

(22) Filed: Jan. 24, 2023

(30) Foreign Application Priority Data
Feb. 10, 2022 (TW) 111201407

(51) Int. Cl. F16C 11/04; E05D 7/04

(52) U.S. Cl. CPC F16C 11/04; E05D 7/0407

(57) ABSTRACT

A thin hinge includes a rotating part including a rotating member and a support frame; and a torsion providing part. The rotating member includes a first arcuate part and a second arcuate part, the first arcuate part forms two guide slots, the frame forms two lugs disposed in the guide slots and making the first arcuate part rotatable relative to the frame, the first and second arcuate parts open and close sequentially based on a rotation angle of the rotating member. The torsion providing part includes an assembly shaft disposed on the frame, a rotating shaft assembled to the second arcuate part, and a torsion providing member connected to the rotating and assembly shafts and providing torsion for the rotating member, the torsion providing member is composed of connecting rods moving with the rotating shaft when the second arcuate part is manipulated, and driving the assembly shaft to rotate.

### FIELD OF THE INVENTION

The invention relates to a hinge, and more particularly to a thin hinge.

### BACKGROUND OF THE INVENTION

In order to realize the opening and closing action of electronic products, a hinge structure is provided on electronic products. With the development and progress of science and technology, in order to minimize the size of electronic products, the sizes of electronic products are reduced, hinges must also be designed to be thinner to match with electronic products.

In addition, existing thin hinge structures are disclosed in U.S. Pat. No. 10,620,672B and Chinese Patent No. CN 207315850U. Taking the patent of U.S. Pat. No. 10,620,672B as an example, the hinge comprises a mounting frame and a hinge arm disposed on the mounting frame, wherein the hinge arm is composed of two rotating parts. During implementation, the two rotating parts can be unfolded or folded sequentially based on a working state of the thin hinge. However, the conventional thin hinge tends to have insufficient torsion, which makes it difficult for the two rotating parts to provide a good opening and closing experience for users.

In order to solve the aforementioned problems, Taiwan Patent No. TW M622164 filed by the applicant of the invention improves the drawbacks of conventional hinges, at the same time, and the applicant of the invention is still thinking about ways to further improve hinges, so the invention is provided herein.

### SUMMARY OF THE INVENTION

A main object of the invention is to solve the problem of insufficient torsion in conventional thin hinge devices.

In order to achieve the above object, the invention provides a thin hinge including a rotating part and a torsion providing part. The rotating part includes a rotating member and a support frame for disposing the rotating member, the rotating member is composed of a first arcuate part and a second arcuate part connected to the first arcuate part, the first arcuate part forms two guide slots facing the support frame respectively, the support frame is formed with two lugs that are disposed in the two guide slots, the first arcuate part rotates relative to the two lugs of the support frame, and the first arcuate part and the second arcuate part are sequentially opened and closed based on a rotation angle of the rotating member. The torsion providing part includes an assembly shaft disposed on the support frame, a rotating shaft assembled to the second arcuate part, and a torsion providing member connected to the rotating shaft and the assembly shaft and providing torsion for the rotating member, the torsion providing member is composed of a plurality of connecting rods assembled in hinge connection, and the plurality of connecting rods move with the rotating shaft when the second arcuate part is manipulated, and drive the assembly shaft to rotate.

In one embodiment, one of the plurality of connecting rods includes an assembly arm connected to the assembly shaft.

In one embodiment, an other one of the plurality of connecting rods is formed with a through hole provided for inserting the rotating shaft therein.

In one embodiment, a number of the plurality of connecting rods is two.

In one embodiment, one of the plurality of connecting rods includes a first assembly part, an other one of the plurality of connecting rods includes a second assembly part hinge-connected to the first assembly part, and the first assembly part corresponds to the second assembly part.

In one embodiment, the second arcuate part forms an assembly groove provided for disposing the torsion providing member.

In one embodiment, the first arcuate part is formed with two sliding slots respectively disposed on two sides of the first arcuate part facing the second arcuate part, and the second arcuate part is formed with two sliding blocks respectively disposed in the two sliding slots.

In one embodiment, the support frame includes a frame body connected with the first arcuate part, the two lugs are provided on the frame body, and an outer frame disposed on the assembly shaft.

In one embodiment, the frame body is formed with two notches, and the first arcuate part includes two protrusions movable in the two notches.

Through the foregoing implementation of the invention, the invention has the following features compared with the conventional technique: the invention is implemented through a structure with the torsion providing member and the connecting rods. When the rotating member is manipulated to rotate, the connecting rods provide the rotating member with torsion, and moves with the rotating shaft to drive the assembly shaft to rotate.

### BRIEF DESCRIPTION OF THE DRAWINGS

FIG. 1 is a perspective view of an embodiment of the invention.

FIG. 2 is an exploded structural view of the embodiment of the invention.

FIG. 3 is an exploded structural view of another direction of the embodiment of the invention.

FIG. 4 is a cross-sectional view along A-A section line in FIG. 1.

FIG. 5 is a cross-sectional view of an implementation state of the embodiment of the invention.

FIG. 6 is a cross-sectional view of an other implementation state of the embodiment of the invention.

### DETAILED DESCRIPTION OF THE PREFERRED EMBODIMENTS

The detailed description and technical content of the invention are described below with reference to the accompanying drawings.

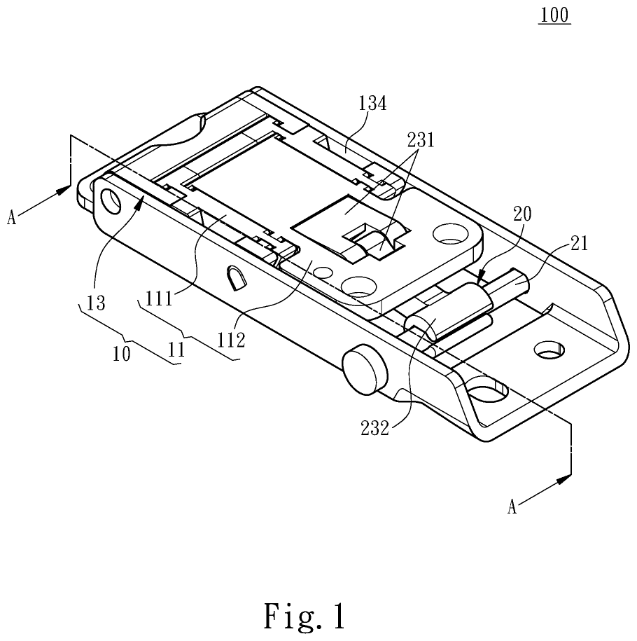

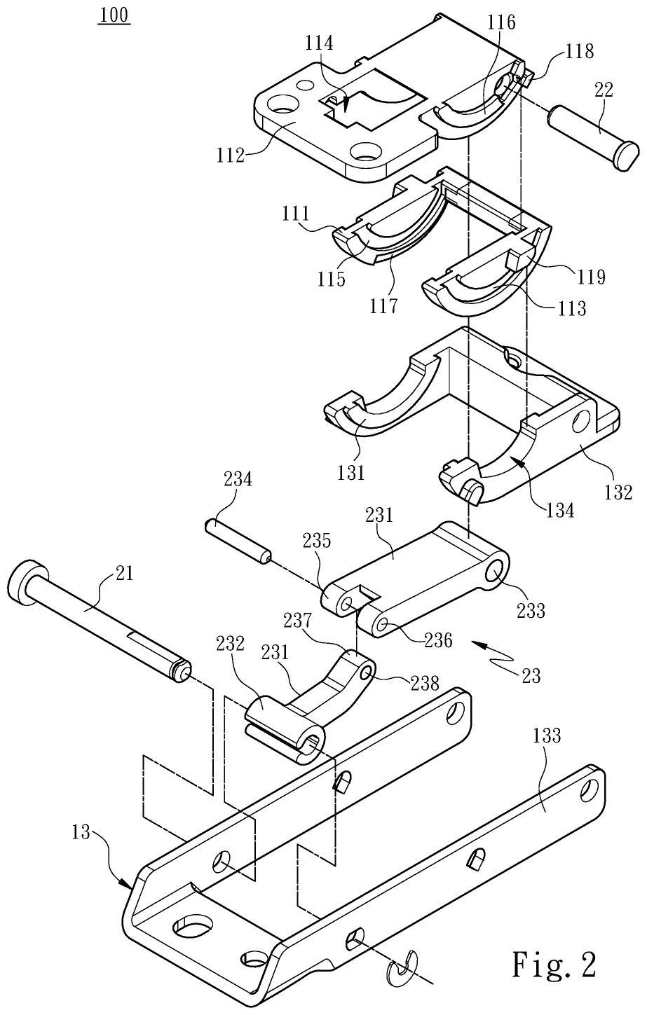

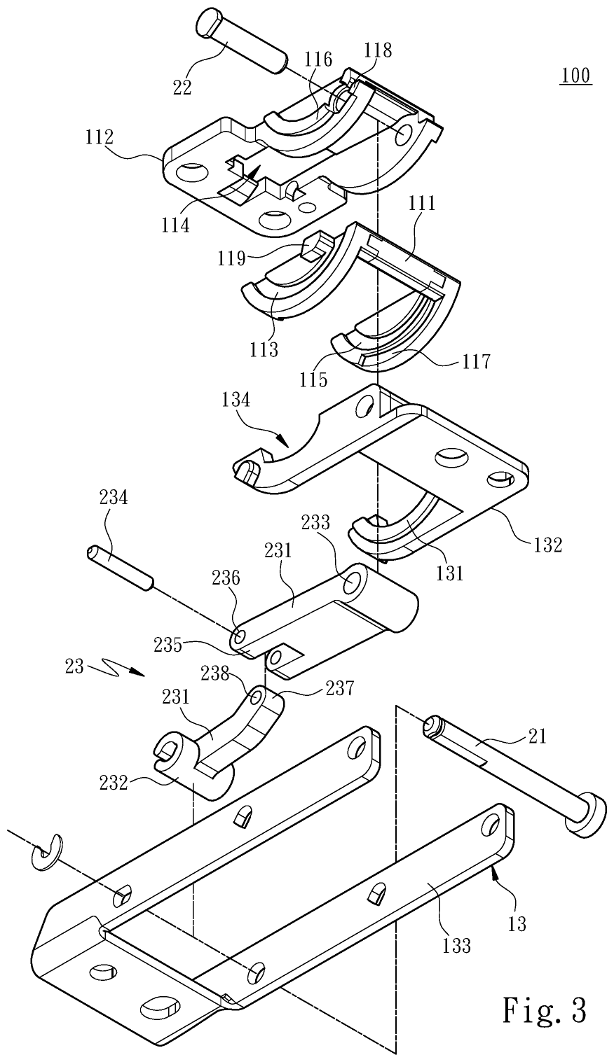

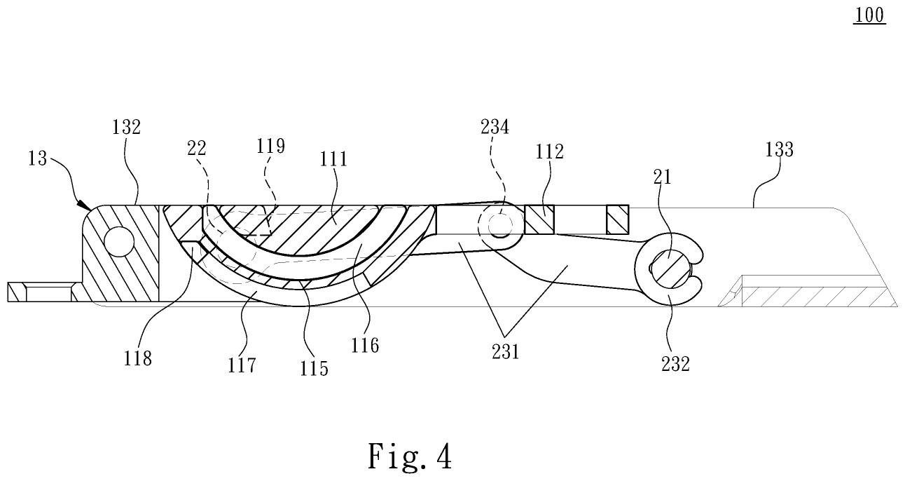

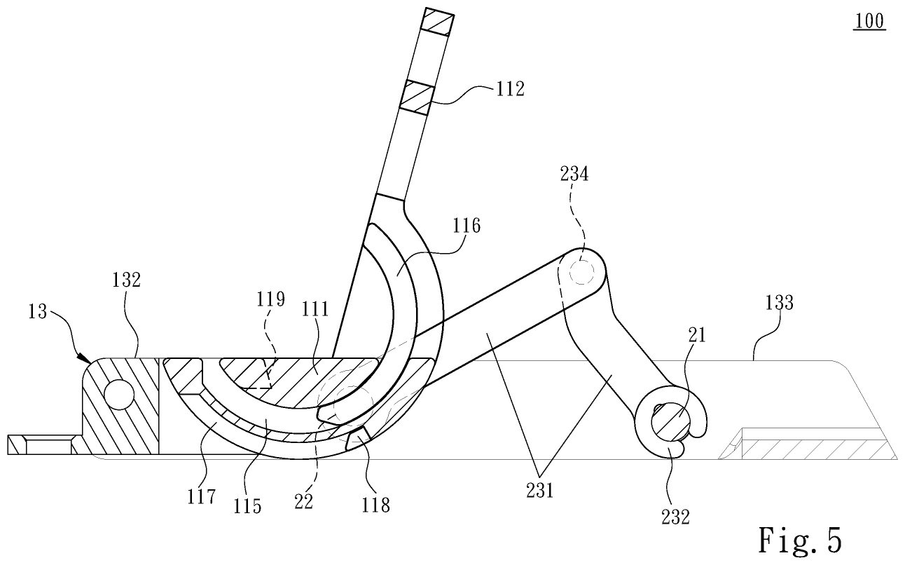

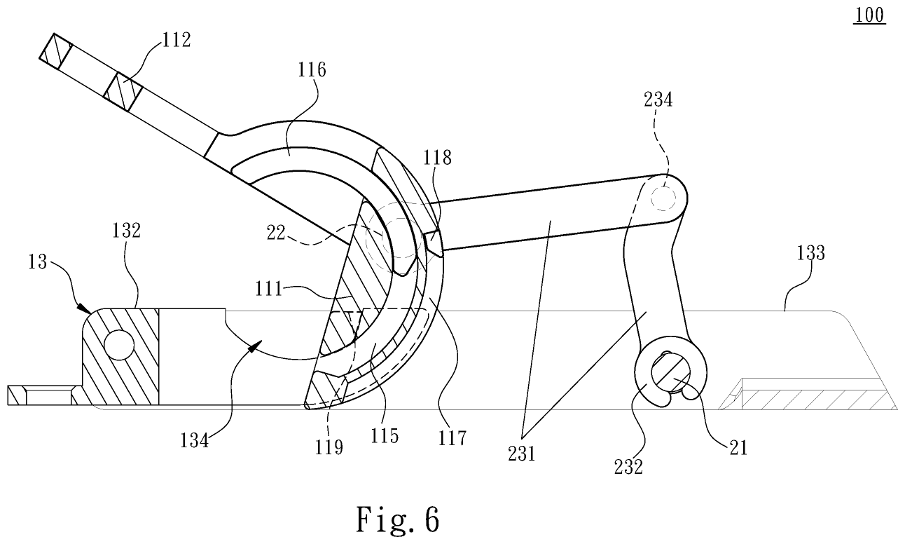

Please refer to FIG. 1, FIG. 2, FIG. 3, FIG. 4, FIG. 5, and FIG. 6, the invention provides a thin hinge 100, the thin hinge 100 includes a rotating part 10 and a torsion providing part 20, the rotating part 10 includes a rotating member 11 and a support frame 13 for disposing the rotating member 11. The rotating member 11 is composed of a first arcuate part 111 and a second arcuate part 112. The first arcuate part 111 is connected to the support frame 13 and rotates relative to the support frame 13. Specifically, the first arcuate part 111 is formed with two guide slots 113. The two guide slots 113 are located on two opposite sides of the first arcuate part 111, and face the support frame 13 respectively. The support frame 13 includes two lugs 131, the two lugs 131 are disposed in the two guide slots 113, and move along the two guide slots 113 when the first arcuate part 111 rotates, and the two lugs 131 make the first arcuate part 111 rotatable relative to the support frame 13. In addition, the second arcuate part 112 is connected to the first arcuate part 111, the second arcuate part 112 rotates when the rotating member 11 is manipulated, and then drives the first arcuate part 111 to rotate.

The torsion providing part 20 is connected with the rotating part 10, and the torsion providing part 20 includes an assembly shaft 21, a rotating shaft 22 and a torsion providing member 23. The assembly shaft 21 is disposed on the support frame 13 and rotates relative to the support frame 13. The rotating shaft 22 is disposed on the second arcuate part 112 and is driven by the second arcuate part 112. The torsion providing member 23 is connected with the rotating shaft 22 and the assembly shaft 21. The torsion providing member 23 is composed of a plurality of connecting rods 231, and the connecting rods 231 form an assembly relationship in an hinge connection. When the rotating member 11 rotates, the connecting rods 231 move along with the rotating member 11, and provide a torsion required for the rotating member 11 at the same time.

Please refer to FIG. 1, FIG. 2, FIG. 3, FIG. 4, FIG. 5, and FIG. 6, implementation of the thin hinge 100 will now be described hereunder. First, it is assumed that the rotating member 11 of the thin hinge 100 in an initial state is not rotating, and the first arcuate part 111 and the second arcuate part 112 are located on the support frame 13 in a folded manner, as shown in FIG. 1. When the rotating member 11 is manipulated, the second arcuate part 112 starts to rotate, while the first arcuate part 111 remains in the initial state. The second arcuate part 112 drives the rotating shaft 22 during rotation, so that the torsion providing member 23 moves with the rotating shaft 22 and drives the assembly shaft 21 to rotate. When the second arcuate part 112 rotates to a fixed angle (for example, “75” degrees) relative to the support frame 13, the second arcuate part 112 starts to drive the first arcuate part 111, and the torsion providing member 23 continues to be acted by the second arcuate part 112, and drives the assembly shaft 21 to rotate. When the first arcuate part 111 rotates to a set angle, such as “75” degrees, relative to the support frame 13, and the second arcuate part 112 rotates to “150” degrees relative to the support frame 13, the torsion providing member 23 stops driving the assembly shaft 21 to rotate and provides support for the second arcuate part 112.

It can be known from the above that the invention is opened and closed sequentially based on a rotation angle of the first arcuate part 111 and the second arcuate part 112 of the rotating member 11, and at the same time through cooperation of the torsion providing member 23, the rotating member 11 obtains torsion during rotation, and the torsion providing member 23 supports the second arcuate part 112 when the rotating member 11 completes rotation, so as to provide a better use experience compared with conventional hinges.

Please refer to FIG. 2, in one embodiment, one of the connecting rods 231 of the invention includes an assembly arm 232, the assembly arm 232 is used to connect with the assembly shaft 21, the other one of the connecting rods 231 is formed with a through hole 233, and the through hole 233 is provided for the rotating shaft 22 to insert therein. The invention enables the connecting rods 231 to be disposed on the assembly shaft 21 and the rotating shaft 22 through disposition of the assembly arm 232 and the through hole 233.

In one embodiment, a number of the connecting rods 231 in the invention is set to two. In order to make assembly between the two connecting rods 231 stable, the torsion providing member 23 includes a shaft 234, one of the two connecting rods 231 includes a first assembly part 235 and at least one first opening 236 provided on the first assembly part 235, and the other connecting rod 231 includes a second assembly part 237 and at least one second opening 238 provided on the second assembly part 237, the first assembly part 235 corresponds to the second assembly part 237, the at least one first opening 236 and the at least one second opening 238 are located on a same axis, and the shaft 234 is inserted into the at least one first opening 236 and the at least one second opening 238 in sequence. In addition, in one embodiment, in order to prevent the connecting rods 231 from interfering with the second arcuate part 112, the second arcuate part 112 forms an assembly groove 114, and the assembly groove 114 is provided for the torsion providing member 23 to dispose therein. When the second arcuate part 112 is not opened, the torsion providing member 23 is accommodated in the assembly groove 114, and at the same time an assembly space required by the thin hinge 100 is reduced.

On the other hand, in order to enable the first arcuate part 111 and the second arcuate part 112 of the invention to unfold sequentially, the first arcuate part 111 is formed with two sliding slots 115, and the two sliding slots 115 are respectively disposed on two sides of the first arcuate part 111 facing the second arcuate part 112. The second arcuate part 112 is formed with two sliding blocks 116, the two sliding blocks 116 cooperate with one of the sliding slots 115 respectively, and the two sliding blocks 116 slide along the two sliding slots 115 when the second arcuate part 112 rotates, thereby reducing misalignment between the second arcuate part 112 and the first arcuate part 111. In another embodiment, in order to increase stability of rotation of the second arcuate part 112 and the first arcuate part 111 of the invention, the first arcuate part 111 is formed with two auxiliary guide slots 117, the two auxiliary guide slots 117 are located on two opposite sides of the first arcuate part 111 and respectively face the second arcuate part 112. The two auxiliary guide slots 117 are spaced apart from the two sliding slots 115. The second arcuate part 112 is formed with two auxiliary sliding blocks 118, the two auxiliary sliding blocks 118 cooperate with the two auxiliary guide slots 117, and slide along the two auxiliary guide slots 117 when the second arcuate part 112 rotates.

On the other hand, please refer to FIG. 2 and FIG. 3, the support frame 13 includes a frame body 132 and an outer frame 133, the frame body 132 is connected with the first arcuate part 111, the two lugs are provided on the frame body, and the outer frame 133 is disposed outside the frame body 132 and provided for the assembly shaft 21 to dispose thereon. In one embodiment, the frame body 132 is formed with two notches 134, the two notches 134 are exposed on a surface of the frame body 132, the first arcuate part 111 includes two protrusions 119, the two protrusions 119 are disposed in the two notches 134, and move in the two notches 134 when the first arcuate part 111 rotates relative to the support frame 13.

What is claimed is:

1. A thin hinge, comprising:
a rotating part, comprising a rotating member and a support frame for disposing the rotating member, the rotating member composed of a first arcuate part and a second arcuate part connected to the first arcuate part, the first arcuate part formed with two guide slots facing the support frame respectively, the support frame formed with two lugs disposed in the two guide slots, the first arcuate part rotating relative to the two lugs of the support frame, and the first arcuate part and the second arcuate part sequentially unfolded or folded based on a rotation angle of the rotating member; and
a torsion providing part, comprising an assembly shaft disposed on the support frame, a rotating shaft assembled to the second arcuate part, and a torsion providing member connected to the rotating shaft and the assembly shaft and providing torsion for the rotating member, the torsion providing member composed of a plurality of connecting rods assembled in hinge connection, the plurality of connecting rods moving with the rotating shaft when the second arcuate part being manipulated, and the plurality of connecting rods driving the assembly shaft to rotate.

2. The thin hinge as claimed in claim 1, wherein one of the plurality of connecting rods comprises an assembly arm connected to the assembly shaft.

3. The thin hinge as claimed in claim 2, wherein an other one of the plurality of connecting rods is formed with a through hole provided for inserting the rotating shaft therein.

4. The thin hinge as claimed in claim 3, wherein a number of the plurality of connecting rods is two.

5. The thin hinge as claimed in claim 4, wherein one of the plurality of connecting rods comprises a first assembly part, an other one of the plurality of connecting rods comprises a second assembly part hinge-connected to the first assembly part, and the first assembly part corresponds to the second assembly part.

6. The thin hinge as claimed in claim 1, wherein the second arcuate part forms an assembly groove provided for disposing the torsion providing member.

7. The thin hinge as claimed in claim 6, wherein the first arcuate part is formed with two sliding slots respectively disposed on two sides of the first arcuate part facing the second arcuate part, and the second arcuate part is formed with two sliding blocks respectively disposed in the two sliding slots.

8. The thin hinge as claimed in claim 7, wherein the support frame comprises a frame body connected with the first arcuate part, the two lugs are provided on the frame body, and an outer frame disposed on the assembly shaft.

9. The thin hinge as claimed in claim 8, wherein the frame body is formed with two notches, and the first arcuate part comprises two protrusions movable in the two notches.
